(19) United States
(12) Patent Application Publication
(10) Pub. No.: US 2005/0135484 A1
(43) Pub. Date: Jun. 23, 2005

(54) Method of encoding mode determination, method of motion estimation and encoding apparatus

(75) Inventors: Yung-lyul Lee, Seoul (KR); Ki-hoon Han, Seoul (KR)

Correspondence Address: STAAS & HALSEY LLP, SUITE 700, 1201 NEW YORK AVENUE, N.W., WASHINGTON, DC, 20005, US

(73) Assignees: DAEYANG FOUNDATION (SEJONG UNIVERSITY), Seoul (KR); Samsung Electronics Co., Ltd., Suwon-si (KR)

(21) Appl. No.: 10/861,486

(22) Filed: Jun. 7, 2004

(30) Foreign Application Priority Data
Dec. 18, 2003 (KR) 2003-93158

(51) Int. Cl. H04N 7/12

(52) U.S. Cl. 375/240.16; 375/240.12; 375/240.24; 348/699; 375/240.2; 375/240.03

(57) ABSTRACT

Motion estimation of a macro block in inter16×16, inter16×8, and inter8×16 modes is performed and a determination of whether to further perform motion estimation in a P8×8 mode is made. Motion estimation in P8×8 mode is either omitted or performed and one mode is determined according to a rate distortion cost of the respective modes. Spatial prediction encoding may then be performed or omitted based on comparing the rate distortion cost of the one mode with a predetermined value. Accordingly, by selectively omitting variable block motion estimation and spatial prediction encoding which are the most complicated operations in an H.264 encoder, determining an encoding mode is rapidly performed such that encoding speed increases.

### CROSS-REFERENCE TO RELATED APPLICATIONS

This application claims the benefit of Korean Patent Application No. 2003-93158, filed Dec. 18, 2003, in the Korean Intellectual Property Office the disclosure of which is incorporated herein by reference.

### BACKGROUND OF THE INVENTION

1. Field of the Invention

The present invention relates to encoding moving picture data, and more particularly, to an apparatus for and a method of determining an encoding mode at a high speed by omitting variable block motion estimation and spatial prediction encoding when an encoding mode is determined by using rate-distortion optimization and a method of motion estimation.

2. Description of the Related Art

Motion estimation in video coding standards, such as H.263, MPEG-4, and H.264, is performed in units of blocks. That is, motion estimation is performed in units of macro blocks, or in units of sub-blocks that are obtained by dividing a macro block into two or four sub-blocks. Motion estimation is performed to reduce bit rate by removing temporal redundancy when moving pictures are encoded. In particular, H.264 uses variable block-based motion estimation and therefore has a high encoding efficiency. In addition, H.264 performs motion vector prediction in units of ¼ pixels such that more accurate motion estimation than MPEG-4 is enabled.

Prediction of a motion vector is performed by referring to a previous picture on a time axis, or by referring to both a previous picture and a subsequent picture. Frames that are referenced when a current frame is coded or decoded are called reference frames. Since H.264 supports multiple reference frames and selects a block of a frame most similar to a current block as a reference frame, H.264 achieves a higher encoding efficiency than methods using only a previous frame as a reference frame.

In order to select an optimum mode among all available encoding modes, a rate-distortion optimization technology is used such that the encoding efficiency of H.264 baseline profile (BP) is further improved. Examples of available encoding modes include the variable block mode used in motion estimation, three spatial prediction modes (Intra16×16, Intra4×4, IBLOCK), and a SKIP mode. Based on the rate-distortion optimization technology, encoding technology, H.264 can compress 1.5 to 2 times more data than conventional H.263 or MPEG-4 simple profile (SP), while achieving a same picture quality.

However, as described above, there are multiple encoding modes in H.264 and in order to select an optimum encoding mode among them, motion estimation should be performed in all encoding modes. Accordingly, calculation is complicated and an amount of computation is huge such that calculations which are approximately 16 times more complicated than MPEG-4 SP encoding are needed. Therefore, a method of determining an encoding mode by which this complexity is reduced and H.264 may be easily applied is needed.

### SUMMARY OF THE INVENTION

The present invention provides a method of encoding mode determination by which when encoding is performed complying with the H.264 standard, variable block motion estimation and spatial prediction encoding, which require the largest amount of computation and time, are efficiently omitted and an encoding mode is fast determined through rate-distortion optimization.

According to an aspect of the present invention, there is provided a method of determining an encoding mode comprising: performing motion estimation of a macro block in an inter16×16 mode, an inter16×8 mode, and an inter8×16 mode; determining whether to further perform motion estimation in a P8×8 mode; according to the determination result, omitting or performing motion estimation in the P8×8 mode and then selecting one mode from among the modes for which motion estimation has been performed; omitting or performing spatial prediction encoding according to a rate-distortion cost value of the selected mode and determining a final encoding mode.

In the method, the performing of the motion estimation and then determining whether to further perform motion estimation in P8×8 mode comprises: performing motion estimation of a macro block in Inter16×16 mode, Inter16×8 mode, and Inter8×16 mode; in each of the modes, for each of the modes, calculating a sum of absolute difference (SAD) value that is the difference of the pixel value of a current picture and the pixel value of a previous picture, and an MVcost that is a difference value of the motion vector of a current picture and the motion vector of a previous picture; and comparing a sum of the SAD and the MVcost values (SAD+MVcost) of respective modes and according to the result of comparison, determining whether to further perform motion estimation in the P8×8 mode.

According to another aspect of the present invention, there is provided a method of motion estimation of a macro block comprising: performing motion estimation by using the entire macro block; dividing the macro block into two blocks in the horizontal direction or the vertical direction and then performing motion estimation by using each divided block; dividing the macro block into four blocks of an identical size and performing motion estimation by using each divided block; dividing each of the four divided blocks into two blocks in the horizontal direction or the vertical direction and performing motion estimation by using each further divided block; and dividing each of the four divided blocks into four and performing motion estimation by using each further divided block.

According to still another aspect of the present invention, there is provided an encoding apparatus comprising: a DCT+Q performing unit which receives picture data and performs discrete cosine transform (DCT) and quantization; a rate-distortion optimization unit which calculates a rate-distortion cost of the picture and determines an encoding block mode to be used in encoding the picture, and transfers the determined block mode to the DCT+Q performing unit; and a motion estimator and a motion compensator which by using a reference frame and the input picture, performs motion estimation and compensation and transfers the result to the DCT+Q performing unit.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a diagram showing variable blocks used in motion estimation;

FIG. 2 is a diagram showing an example of block selection;

FIG. 3 is a block diagram of an H.264 encoder;

FIG. 4 is a diagram to explain determining an encoding mode by rate-distortion optimization;

FIG. 5 is a diagram showing the directions of 9 prediction modes in Intra4×4 mode;

FIG. 6 is a flowchart showing a block matching sequence when variable block motion estimation is performed;

FIG. 7 is a flowchart of operations performed by a method of encoding mode determination of the present invention;

FIG. 8A is a detailed flowchart of operation S740 of FIG. 7;

FIG. 8B is a detailed flowchart of operations S760, S770 and S780 of FIG. 7; and

FIGS. 9A through 9G are graphs comparing peak signal-to-noise ratios (PSNRs) when a method of encoding mode determination of the present invention, the H.264 method, and the Simple H.264 method are used.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

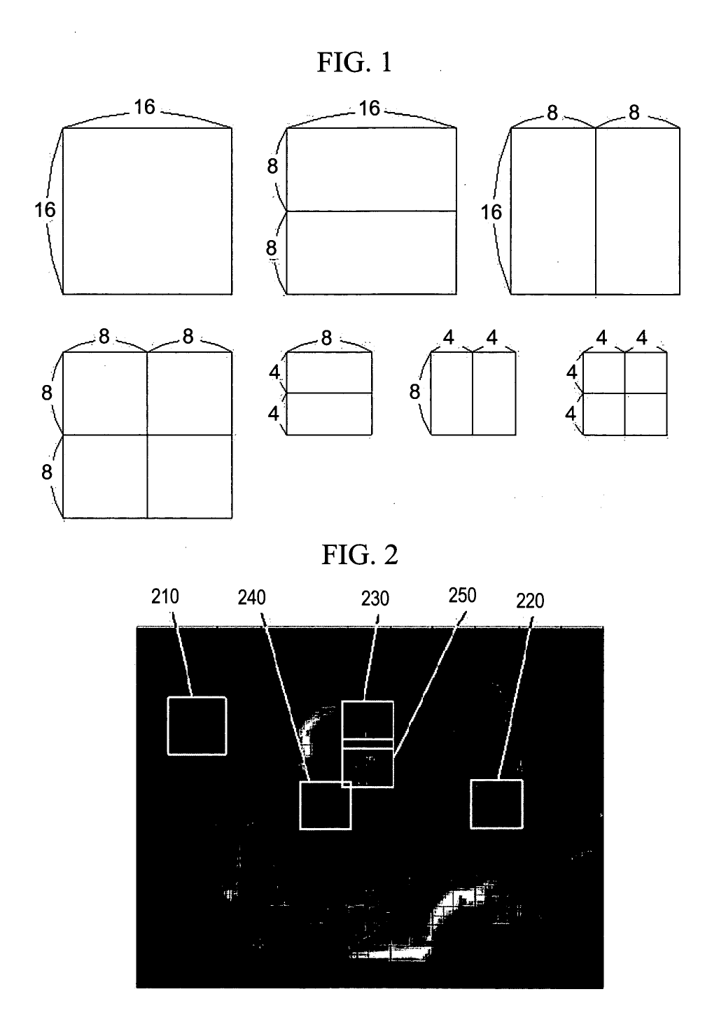

FIG. 1 is a diagram showing variable blocks used in motion estimation. In motion estimation, H.264 divides one 16×16 macro block into 16×8 blocks, 8×16 blocks, and 8×8 blocks, and further divides one 8×8 block into 8×4 blocks, 4×8 blocks, and 4×4 blocks and by selecting according to a picture, performs motion estimation. Performing motion estimation using these various types of variable blocks enables H.264 to efficiently perform encoding with respect to characteristics and motions of pictures. The efficiency results because motion estimation and encoding performed by using a large block for a case where motion in a picture is simple and an object is large and a small block for a case where motion in a picture is complicated and an object is small is effective.

FIG. 2 is a diagram showing an example of block selection. Referring to FIG. 2, for a background part 210 or a simple part 220 of an object to be encoded 16×16 blocks are used, while 16×8 blocks and 8×16 blocks are used for complicated parts 230 and 240 and less blocks such as 8×4, 4×8, and 4×4 blocks are used for the more complicated part 250.

For determining an encoding mode, in order to select an optimum mode among all available encoding modes, such as the variable block mode used in H.264, three types of spatial prediction modes, and SKIP mode, rate-distortion optimization is performed and a mode minimizing a rate-distortion cost (RDcost) is determined as the encoding mode. The spatial prediction mode means an intra prediction mode, SKIP mode corresponds to a case where a pixel value of a macro block of a previous frame is the same as a pixel value of a macro block of a current frame such that encoding is not needed. The RDcost is calculated, considering distortion and rates for each mode, according to equation 1.
RDcost=Distortion+λ_{Mode}×Rates (1)

In the equation 1, Distortion denotes a difference of pixel values between a current picture and a restored picture and is calculated according to equation 2. Rates denotes a transmission bitrate of the encoded data.

$$Distortion = {\sum }_{k = 0}^{15} {\sum }_{l = 0}^{15} {( B ( k , l ) - {B}^{′} ( k , l ) )}^{2} \qquad ( 2 )$$

In the equation 2, B(k,l) and B′(k,l) denote (k,l)-th pixel values of the current macro block and the restored macro block, respectively. The λ_{Mode} is a Lagrangian constant and is calculated according to equation 3:
λ_{Mode}=0.85×2^{(QP-12)/3} (3)

In the equation 3, QP denotes an integer from 0 to 51 and is an H.264 quantization value.

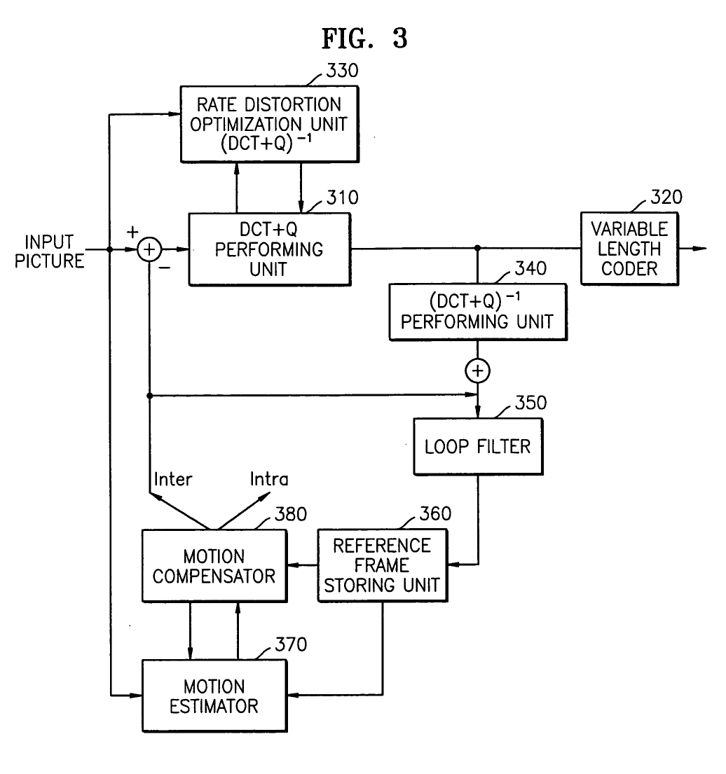

FIG. 3 is a block diagram of an H.264 encoder. The H.264 decoder comprises a DCT+Q performing unit 310, a variable length coder 320, a rate-distortion optimization unit 330, a (DCT+Q)⁻¹ performing unit 340, a loop filter 350, a reference frame storing unit 360, a motion estimator 370, and a motion compensator 380.

When an input picture is input to the DCT+Q performing unit 310, DCT and quantization are performed and then, in the variable length coder 320, context-based adaptive variable length coding is performed. At this time, the input picture is also input to the rate-distortion optimization unit 330 and (DCT+Q)⁻¹ is performed. Then, an optimum block mode is determined and output to the DCT+Q performing unit 310.

With the DCT+Q performed picture, (DCT+Q)⁻¹ is performed in the (DCT+Q)⁻¹ performing unit 340, low pass filtering is performed in the loop filter 350 to smooth block boundaries, and then the picture is stored in the reference frame storing unit 360. With the thus stored reference frame and input picture, the motion estimator 370 performs motion estimation and transfers the result to the motion compensator 380. The motion compensator 380 determines whether to subtract the reference frame from the input picture, according to whether the input picture to be encoded is an inter frame or an intra frame, and transfers the reference frame to the DCT+Q performing unit 310.

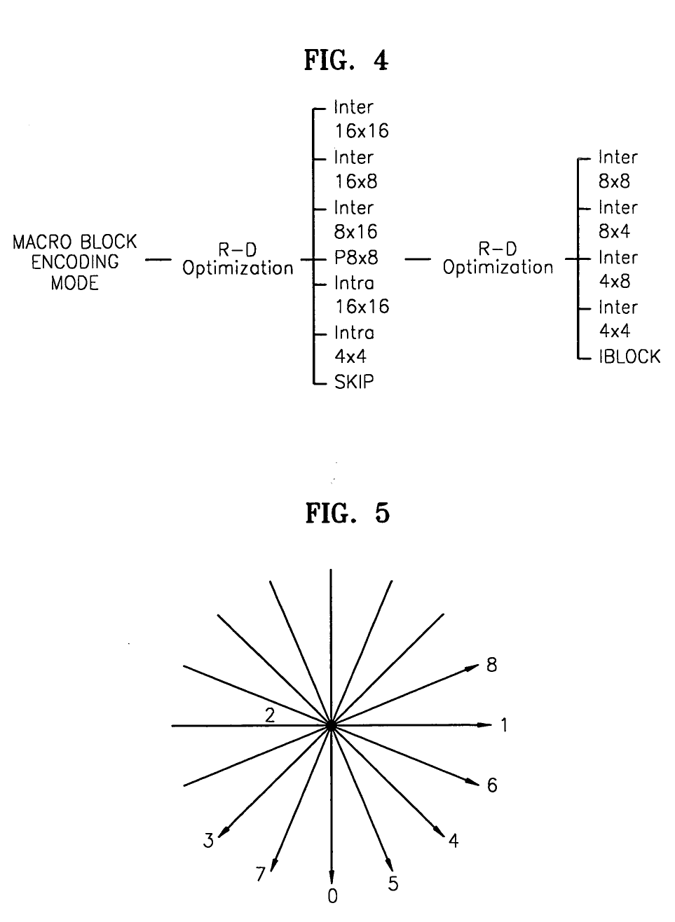

FIG. 4 is a diagram to explain determining an encoding mode by rate-distortion optimization. Referring to FIG. 4, as encoding modes of a macro block, there are 7 modes, including Inter16×16, Inter16×8, Inter8×16, P8×8, Intra16×16, Intra4×4, and SKIP mode. The P8×8 mode may be further broken down to 5 modes. If the P8×8 mode is selected, rate-distortion optimization is performed independently for each of four 8×8 blocks in a macro block and one mode is selected among five modes, including an Inter8×8 mode, an Inter8×4, an Inter4×8, an Inter4×4, and an IBLOCK mode. The SKIP mode has a (0,0) vector or motion vector of the Inter16×16 mode, and corresponds to a case where after DCT and quantization are performed, a residual signal is all 0. The IBLOCK mode is to encode an 8×8 block into the Intra4×4 mode. Referring to FIG. 5, the Intra4×4 mode will now be explained.

FIG. 5 is a diagram showing directions of 9 prediction modes in the Intra4×4 mode. Referring to FIG. 5, block prediction is performed in the vertical direction, horizontal direction, and diagonal directions so that the direction corresponds to a name of a mode. The Intra4×4 mode includes a vertical mode 0, a horizontal mode 1, a DC mode 2, a diagonal_down_left mode 3, diagonal_down_right mode 4, vertical_right mode 5, horizontal_down mode 6, vertical_left mode 7, and horizontal_up mode 8. In the DC mode, all samples in a block are predicted based on samples in adjacent blocks.

In Intra4×4 mode, RDcost is calculated for all nine prediction directions. In order to calculate RDcost using the equation 1, 4×4 integer DCT+quantization, Entropy encoding, Entropy decoding and (DCT+Q)⁻¹ should be performed. Since DCT+quantization, Entropy encoding, Entropy decoding and (DCT+Q)⁻¹ are performed in units of 4×4 blocks, if the frequencies of the RDcost calculations in the P8×8 mode and the Inter16×16 mode in a macro block unit are compared, the RDcost calculation is performed 16 times in the Inter16×16 mode (because there are 16 4×4 blocks), while the RDcost calculation is performed 208 times in the P8×8 mode (4 times (4 4×4 blocks)×4 times (Inter8×8, Inter8×4, Inter4×8, Inter4×4)+4 times (4 8×8 blocks)×4 times (4 4×4 blocks)×9 times (9 prediction modes)=208 times. Accordingly, the frequency of the RDcost calculations needed in the P8×8 mode is 13 times more than that in the Inter16×16 mode.

That is, the P8×8 mode needs a much larger computation amount because the P8×8 mode should calculate RDcost for every encoding mode. Accordingly, if an encoding mode of a macro block is fast determined, unnecessary RDcost calculation and motion estimation are omitted such that complexity and computation amount of an encoder are reduced.

Table 1 shows the performances of Simple H.264 and H.264 when quantization parameter (QP) is 28. H.264 performs encoding by performing 7 variable block motion estimation and spatial prediction encoding, while under the same encoding conditions as in H.264, Simple H.264 performs encoding not by using 7 variable block motion estimation and spatial prediction encoding, but by using only inter motion estimation in units of 16×16 blocks. The 7 variable blocks refer a 16×16 block, a 16×8 block, an 8×16 block, an 8×8 block, an 8×4 block, a 4×8 block and a 4×4 block used for motion prediction in H.264. The encoding conditions are explained below.

TABLE 1

| QP = 28 | PSNR | Bitrates(Kbps) | Encoding time(%) |
|---|---|---|---|
| Simple H.264 | 35.29 | 94.96 | 48.3 |
| H.264 | 35.78 | 77.27 | 100.3 |

Referring to Table 1, the effects of variable block motion estimation and spatial prediction encoding on the encoding efficiency and time are shown.

The encoding conditions commonly applied to H.264 and Simple H.264 are as follows. For 300 pictures stored at 30 frames/sec, a picture was compressed at a frame rate of 10 frames/sec, and only a first frame was encoded as Intra frame and all the remaining frames were encoded as Predictive frames. One reference frame was used and encoding was performed by using ±16 search area, motion estimation and compensation in units of ¼ pixel, Hadamard transform, and context-based adaptive variable length coding (CAVLC) for (4×4 integer DCT+Q) coefficient. The pictures used for the experiment is a Foreman QCIF (176×144) picture and quantization parameter values used for the experiment were 28, 32, 36, and 40, respectively.

Table 1 shows the performances in numbers of Simple H.264 and H.264 when QP was 28. Simple H.264 showed a PSNR lower than that of H.264 by 0.49 dB, and a bitrate higher by 22.9%, but an entire encoding time of Simple H.264 is only 48.3% of that of H.264. Accordingly, when variable block motion estimation and spatial prediction encoding are used, the performance of an encoder improves but the complexity increases.

Therefore, in the present invention, a method of encoding mode determination is provided where variable block motion estimation and spatial prediction encoding that need the most amount of computation in an encoder are efficiently omitted and the speed of encoding mode determination is improved through rate-distortion optimization, thus maintaining performance of the encoder while improving the speed of the decoder.

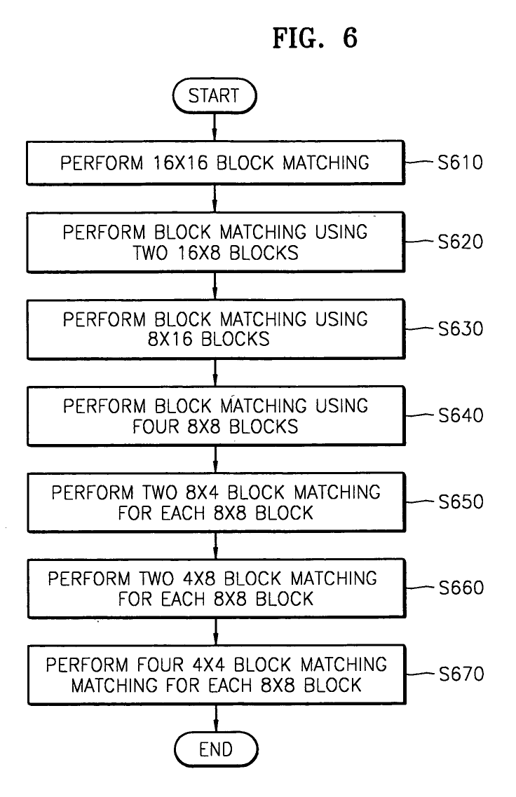

FIG. 6 is a flowchart showing a block matching sequence when variable block motion estimation is performed. First, block matching is performed with a 16×16 block in operation S610 and performed with two 16×8 blocks forming a 16×16 block in operation S620. Then, block matching is performed with two 8×16 blocks in operation S630 and after a 16×16 block is divided into four 8×8 blocks, block matching is performed with each 8×8 block in operation S640.

Next, each 8×8 block is divided into two 8×4 blocks and block matching is performed in operation S650. Each 8×8 block is divided into two 4×8 blocks and block matching is performed in operation S660. Each 8×8 block is divided into four 4×4 blocks and block matching is performed in operation S670.

If variable block motion estimation is performed in the order shown in FIG. 6, unnecessary motion estimation and rate-distortion calculation processes may be omitted. If in variable block motion estimation, a macro block is divided into smaller blocks and then motion estimation is performed, more detailed motion may be expressed than where motion estimation is performed with a 16×16 block, and distortion decreases but the bitrate may increase because motion vectors, coded block patterns, and encoding mode information increase.

From a viewpoint of rate-distortion, if a macro block has motion vectors of various directions and where a block is divided, distortion decreases, motion estimation should be performed with blocks being further divided into much smaller blocks. However, if a block is divided into smaller blocks and the degree of increase in bitrate is greater than the degree of decrease in distortion, it is preferable to maintain a larger block mode.

In the present invention, after motion estimation is performed in the Inter16×16, the Inter16×8, and the Inter8×16 modes, motion estimation and RDcost calculation in the P8×8 mode are omitted for macro blocks in which it is determined that a larger block mode is advantageous in the rate-distortion aspect. In addition, for fast calculation, sum of absolute difference (SAD) and MVcost, instead of distortion and bitrate defined in the equation 2, are used to determine whether to perform motion estimation and RDcost calculation in the P8×8 mode. MVcost is determined by a value obtained by universal variable length coding (UVLC) a difference between a predicted motion vector before motion estimation and a motion vector obtained after motion estimation. If the difference between a predicted vector and an actual motion vector is large, MVcost becomes large, and if the predicted vector is similar to the actual motion vector, MVcost becomes small. SAD+MVcost in Inter16×16, Inter16×8, and Inter8×16 modes are calculated according to equations 4a, 4b and 4c, respectively.
Inter16×16_{—}SAD+MVcost=SAD₁+MVcost₁ (4a)
Inter16×8_{—}SAD+MVcost=SAD₂₁+SAD₂₂+MVcost₂₁+MVcost₂₂ (4b)
Inter8×16_{—}SAD+MVcost=SAD₃₁+SAD₃₂+MVcost₃₁+MVcost₃₂ (4c)

In equations 4a, 4b and 4c, SAD, denotes a SAD value of a 16×16 block, SAD₂₁ denotes a SAD value of a first 16×8 block in the macro block, SAD₂₂ denotes a SAD value of a second 16×8 block, MVcost₂₁ and MVcost₂₂ denote MVcosts of respective 16×8 blocks, and SAD₃₁, SAD₃₂, MVcost₃₁, MVcost₃₂ denote SADs and MVcosts of 8×16 blocks. Generally, SAD₁ SAD₂₁+SAD₂₂ and SAD₁ SAD₃₁+SAD₃₂. This is because as blocks are further divided into smaller blocks, the difference from an actual motion vector decreases.

A value ΔSAD may be determined according to equation 5.
ΔSAD=SAD1−(SAD₂₁+SAD₂₂) (5)

The value ΔSAD denotes a difference value of SAD value in Inter16×16 mode and SAD value in Inter16×8 mode. Accordingly, where two 16×8 blocks in a macro block have motions vectors of different directions, the ΔSAD value increases; where the two 16×8 blocks have motions vectors of similar directions, the ΔSAD value decreases. When two 16×8 blocks have motions vectors of an identical direction, the ΔSAD value is 0.

The difference of the SAD values in the 16×16 block mode and the 8×16 block mode may be thus obtained. Inter16×16_SAD+MVcost of the Inter16×16 mode where motion estimation for a macro block is performed with a 16×16 block, Inter16×8_SAD+MVcost of the Inter16×8 mode where a 16×16 block is horizontally divided into two blocks, and Inter8×16_SAD+MVcost of the Inter8×16 mode where a 16×16 block is vertically divided into two blocks are compared. If the Inter16×16_SAD+MVcost value is the smallest among the compared values, motion vectors of divided blocks are similar where a macro block is divided horizontally, and where divided vertically. Accordingly, the entire macro block moves in a similar direction without being divided into a horizontal direction or a vertical direction, because the degree of increases in MVcost is greater than ΔSAD that is the degree of decreases in SAD.

In this case, even in the P8×8 mode, which requires more motion vectors, MVcost is greater than ΔSAD, motion estimation and RDcost calculation that require more computation may be omitted. As described above, the amount of computation in the P8×8 mode is larger than in the other modes, and if the P8×8 mode motion estimation and rate-distortion optimization processes are omitted when necessary, the amount of computation performed and complexity in an encoder may be greatly reduced. In H.264, after performing motion estimation of a variable block, the RDcost in spatial prediction mode and the RDcost in the SKIP mode are compared and a mode minimizing the RDcost is determined as the encoding mode. In this process, spatial prediction encoding is performed for all macro blocks. Meanwhile, when a picture is encoded, if spatial prediction encoding is performed, a greater number of bits than in Inter prediction encoding by motion estimation are required. However, a case where spatial prediction encoding mode is determined as an encoding mode of a macro block seldom happens, except in special cases such as a scene change.

When encoding is performed complying with conditions recommended by H.264 standardization group, a ratio of a macro block encoded in spatial prediction mode in a predictive frame of a picture is small in all of a variety of pictures. Performing spatial prediction encoding for all macro blocks despite this fact performs unnecessary calculations when the ratio of macro blocks actually encoded in spatial prediction mode is considered.

A method of efficiently omitting unnecessary spatial prediction encoding will now be explained. First, mean M of RDcosts of all Intra macro blocks encoded in spatial prediction mode in previous frames and a current frame is calculated. An Initial M value begins with RDcost mean value of an I frame that is the first frame of a picture, and is updated whenever a macro block encoded in spatial prediction mode occurs. At this time, update M is calculated according to equation 6:

$$M ← \frac{1}{n + 1} ( {M}^{′} + nM ) \qquad ( 6 )$$

In equation 6, M′ denotes the RDcost value when an Intra macro block occurs, and n denotes the number of Intra macro blocks occurring previously. By performing the calculation of the equation 6, M may be continuously updated.

After an encoding mode of an optimum Inter macro block is determined through variable block size motion estimation and rate-distortion optimization, the RDcost of the optimum Inter macro block is compared with M. If the RDcost of the optimum Inter macro block is less than M, motion estimation is efficiently performed and it is highly probable that if spatial prediction mode is performed, the RDcost in the spatial prediction mode becomes greater than the RDcost in the optimum Inter mode. Accordingly, the spatial prediction mode encoding is omitted.

The present invention may also be used for rate-distortion optimization in the P8×8 mode. In the P8×8 mode, the RDcost calculation in IBLOCK mode may be omitted by comparing the RDcost of an optimum mode among the Inter8×8, Inter8×4, Inter4×8, and Inter4×4 modes with M/4 in each 8×8 block.

Spatial prediction encoding omission algorithm of the present invention can be expressed in a pseudo code form as follows.

```
  Inter_mode RDS( ); // Calculate Inter mode Rate Distortions
    Best_Inter_mode_RDcost = Best_Inter_mode_decision( );
      If(Best_Inter_mode_RDcost < M)
        SKIP Intra mode RD calculation;
          else
      Intra_mode_RD( ); // Calculate Intra mode Rate Distortions
Encoding_mode = Encoding_mode_Decision( ); //Decide Intra/Inter
mode
          If(Encoding_mode == Intra)
        Update M value by equation (6);
```

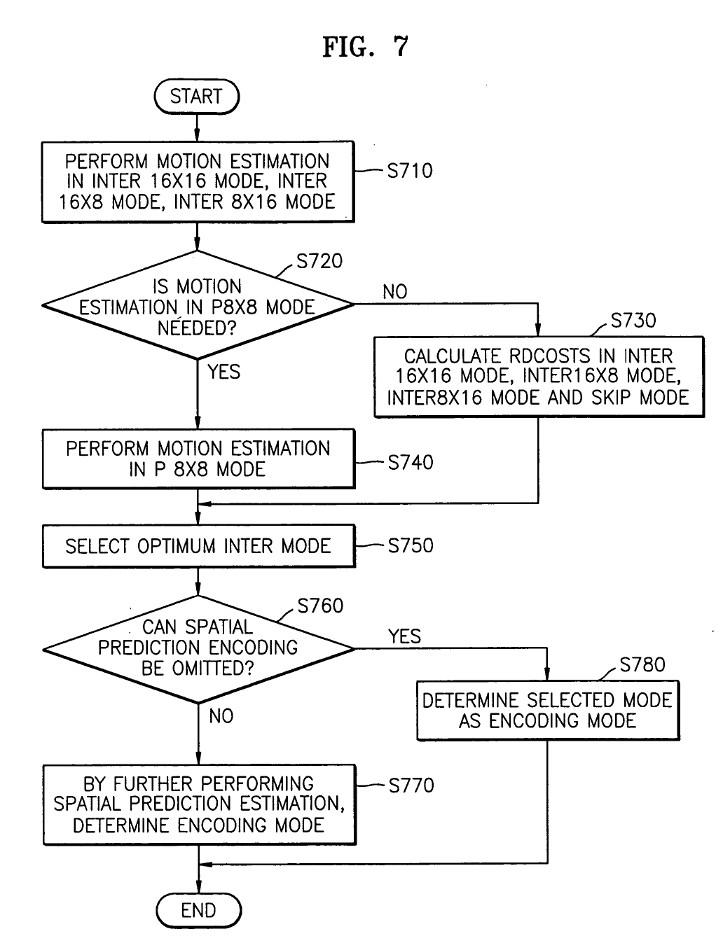

FIG. 7 is a flowchart of the operations performed by a method of encoding mode determination of the present invention.

Motion estimation in three modes, including Inter16×16, Inter16×8, and Inter8×16 modes, is performed in units of macro blocks in operation S710. The operation S710 further includes a process of SAD+MVcost calculation after performing motion estimation. The SAD and MVcost calculation is performed as described above. According to the calculated SAD+MVcost, it is determined whether motion estimation (ME) in the P8×8 mode is needed in operation S720. That is, it is determined whether the Inter16×16_SAD+MVcost is smallest among the three values, by comparing the SAD+MVcost in each mode. If the Inter16×16_SAD+MVcost is the smallest among the three values, maintaining a larger block mode is better than dividing blocks into smaller blocks. Accordingly, the motion estimation (ME) and the RDcost calculation in the P8×8 mode that require a large amount of computation are omitted and the RDcosts in the Inter16×16, Inter16×8, Inter8×16, and SKIP modes are calculated in operation S730.

If a determination result of the operation S720 indicates that the Inter16×16_SAD+MVcost is not the smallest, motion estimation in the P8×8 mode is performed in operation S740.

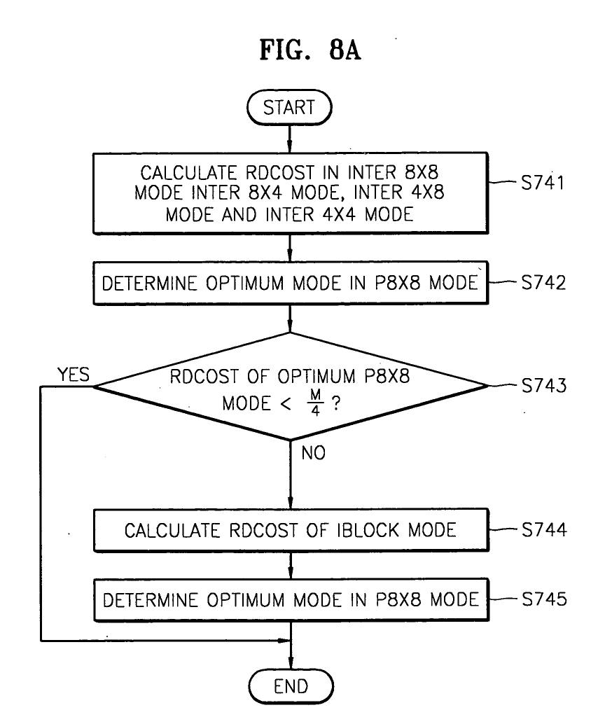

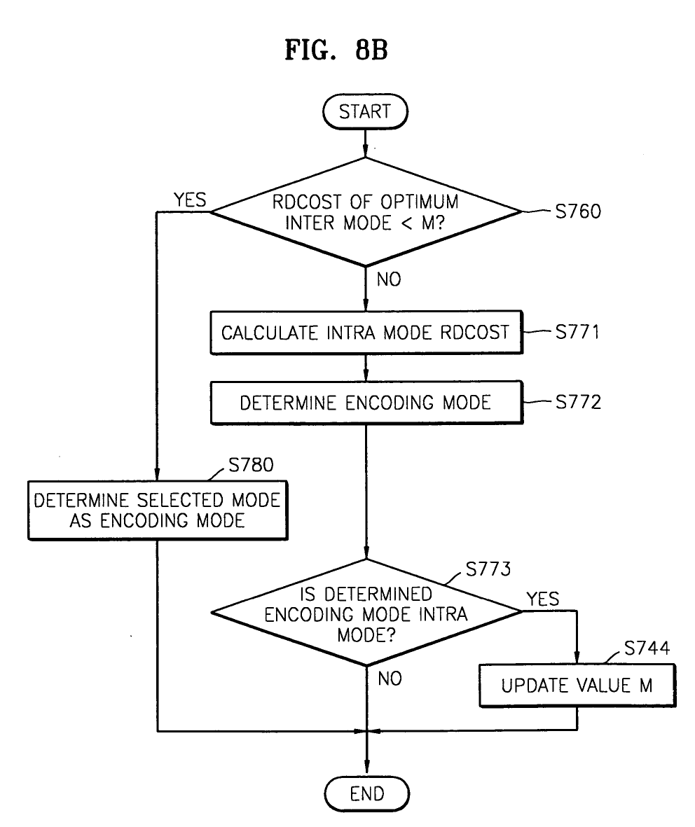

FIG. 8A is a detailed flowchart of operation S740 of FIG. 7. Referring to FIG. 8A, the operation S740 will be explained in more detail. Four 8×8 blocks are further divided and the RDcost of each of the divided blocks is calculated in operation S741. Then, a mode having a smallest RDcost value is determined as an optimum mode in the P8×8 mode in operation 742. The RDcost in the thus determined optimum P8×8 mode is compared with M/4 in operation S743. If the result of the comparison in operation S743 indicates that the RDcost of the optimum P8×8 mode is smaller than M/4, an RDcost calculation of an IBLOCK mode is omitted, or else the RDcost in IBLOCK mode is calculated in operation S744, and an optimum mode in the P8×8 mode is determined in operation S745. If the operation S730 is performed, the mode having the smallest RDcost among the inter16×16 mode, the inter 16×8 mode, the inter8×16 mode and the SKIP mode is selected at operation S750 as the optimum inter mode.

As described above, motion estimation in the P8×8 mode is omitted or performed and then an optimum Inter mode is determined in operation S750. That is, the optimum Inter mode is determined among the Inter16×16, Inter16×8, Inter8×16, SKIP, and P8×8 modes. Then, it is determined whether spatial prediction encoding may be omitted in operation S760. That is, when the RDcost in the mode determined as an optimum Inter mode is compared with the M value, if the RDcost of the optimum Inter mode is less than the M value, motion estimation is efficiently performed, and accordingly, spatial prediction encoding in units of macro blocks is omitted and the Inter mode selected in the operation S750 is determined as the encoding mode in operation S780. If the RD cost of the optimum Inter mode is not less than the M value, spatial prediction encoding is further performed and the RDcost in the spatial prediction mode is calculated, and by comparing the RDcost in the spatial prediction mode with the RDcost in the optimum Inter mode, the encoding mode of a macro block is determined in operation S770.

FIG. 8B is a detailed flowchart of operations S760, S770, and 780 of FIG. 7. By comparing the RDcost in the optimum Inter mode selected in the operation S750 with the M value, it is determined whether to omit spatial prediction encoding in operation S760. Then, the RDcost in Intra mode is calculated in operation S771 and an encoding mode is determined in operation S772. It is determined whether the determined encoding mode is Intra mode in operation S773, and if the determined encoding mode is the Intra mode, the M value is updated in operation S774. The update of the M value is performed according to equation 6 above.

Table 2 shows experimental conditions to explain the effect when an encoding mode is determined according to a method of the present invention.

TABLE 2

| | News | Container | Foreman | Silent | Paris | Mobile | Tempete |
|---|---|---|---|---|---|---|---|
| | (QCIF) | (QCIF) | (QCIF) | (QCIF) | (CIF) | (CIF) | (CIF) |
| Total frame | 300 | 300 | 300 | 300 | 300 | 300 | 260 |
| Frame skip | 2 | 2 | 2 | 1 | 1 | 0 | 0 |

| | |
|---|---|
| QP | 28, 32, 36, 40 |
| Coding Option | Variable block motion estimation, rate-distortion optimization, |
| | Hadamard transform, B frame not used (IPPP . . . ), CAVLC, error tool |
| | not used |

That is, the experiment was conducted complying with experiment conditions recommended by the H.264 standardization group. In addition, by using joint model 42 (JM42) codec, the performance of a method of encoding mode determination of the present invention was experimented.

Tables 3a and 3b compare the performances of the method of encoding mode determination of the present invention and JM42:

TABLE 3a

| | QP | ΔBits (%) | ΔPSNR(dB) | A (%) | B (%) | Total (%) |
|---|---|---|---|---|---|---|
| News | 28 | 1.29 | 0.03 | 94.84 | 36.67 | 75.83 |
| | 32 | 1.35 | 0.04 | 94.90 | 37.38 | 76.05 |
| | 36 | 1.19 | 0.06 | 95.06 | 39.33 | 76.68 |
| | 40 | 1.65 | 0.03 | 94.48 | 42.71 | 77.17 |
| Container | 28 | 0.69 | 0.05 | 94.31 | 38.70 | 75.99 |
| | 32 | 0.91 | 0.04 | 93.16 | 40.88 | 75.78 |
| | 36 | 0.53 | 0.10 | 90.61 | 43.31 | 74.63 |
| | 40 | 0.87 | 0.13 | 89.83 | 45.67 | 74.72 |
| Foreman | 28 | 1.30 | 0.05 | 89.11 | 19.34 | 67.23 |
| | 32 | 0.89 | 0.08 | 89.93 | 23.89 | 69.01 |
| | 36 | 1.11 | 0.07 | 90.20 | 28.70 | 70.48 |
| | 40 | 0.53 | 0.16 | 91.30 | 33.97 | 72.64 |
| Silent | 28 | 1.93 | 0.05 | 96.60 | 33.24 | 76.12 |
| | 32 | 0.96 | 0.00 | 96.63 | 32.48 | 75.93 |
| | 36 | 1.56 | 0.05 | 96.21 | 39.38 | 77.47 |
| | 40 | 0.67 | 0.09 | 96.09 | 43.92 | 78.60 |

TABLE 3b

| | QP | ΔBits (%) | ΔPSNR(dB) | A (%) | B (%) | Total (%) |
|---|---|---|---|---|---|---|
| News | 28 | 0.40 | 0.03 | 94.98 | 35.97 | 75.96 |
| | 32 | 0.40 | 0.05 | 95.24 | 38.51 | 76.81 |
| | 36 | 0.16 | 0.03 | 95.21 | 40.46 | 77.30 |
| | 40 | −0.12 | 0.07 | 95.20 | 41.72 | 77.63 |
| Container | 28 | −0.07 | 0.06 | 96.98 | 27.87 | 75.21 |
| | 32 | −0.15 | 0.05 | 97.95 | 28.12 | 75.96 |
| | 36 | 0.00 | 0.05 | 98.11 | 29.74 | 76.50 |
| | 40 | 0.00 | 0.08 | 97.64 | 33.96 | 77.27 |
| Foreman | 28 | 0.36 | 0.04 | 93.42 | 25.32 | 72.06 |
| | 32 | 0.32 | 0.04 | 94.49 | 28.08 | 73.53 |
| | 36 | 0.32 | 0.05 | 94.80 | 32.04 | 74.49 |
| | 40 | 0.83 | 0.03 | 94.74 | 37.01 | 76.05 |
| Silent | 28 | 0.84 | 0.04 | 94.32 | 31.02 | 74.06 |
| | 32 | 0.60 | 0.04 | 94.61 | 33.04 | 74.72 |
| | 36 | 0.69 | 0.06 | 94.79 | 36.14 | 75.41 |
| | 40 | 0.63 | 0.08 | 94.18 | 39.85 | 76.30 |

In Tables 3a and 3b, ΔBits and ΔPSNR denote differences of bitrates and PSNRs, respectively, of H.264 and the method of mode determination of the present invention, and are calculated according to equations 7a and 7b, respectively.

$$\begin{matrix}ΔBits = \frac{Bits of present invention - Bits of JM42}{Bits of JM42} \times 100 ( \% ) & ( 7 a ) \\ Δ PSNR = PSNR of JM42 - PSNR of present invention & ( 7 b )\end{matrix}$$

A minus sign (−) of ΔBits and ΔPSNR means that performance is improved. In Tables 3a and 3b, A(%) denotes an amount of RD calculation decrease in the spatial prediction encoding process, B(%) denotes an amount of RD calculation decrease in variable block mode used in motion estimation, and Total(%) denotes an amount of RD calculation decrease in the total encoding process. The amount of RD calculation decrease can be calculated according to equation 8:
Amount of calculation decrease=(Frequency of RDcost calculations of JM42−Frequency of RDcost calculations)÷(Frequency of RDcost calculations of JM42)×100(%) (8)

Referring to Tables 3a and 3b, if the method of mode determination of the present invention is used, the amount of computation in a spatial prediction encoding process used in Intra coding decreases by at least 94% in average, and the amount of computation in variable block motion estimation used in Inter coding decreases by at least 31% to 39%. In addition, the total frequency of RD calculations, including spatial prediction mode, variable block mode and even SKIP mode, decreases by at least 75% in average. Compared with the decreases in the amount of computation, the loss in the bitrate is 0.69% in average and the loss in PSNR is 0.55 in average. However, where the degree of decrease in the amount of computation is considered, the effect to the picture quality is not so large.

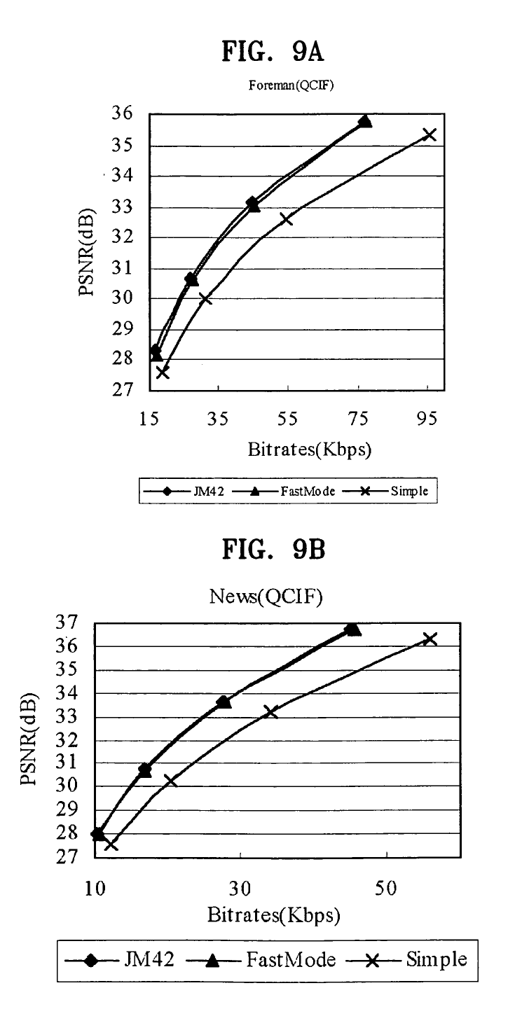

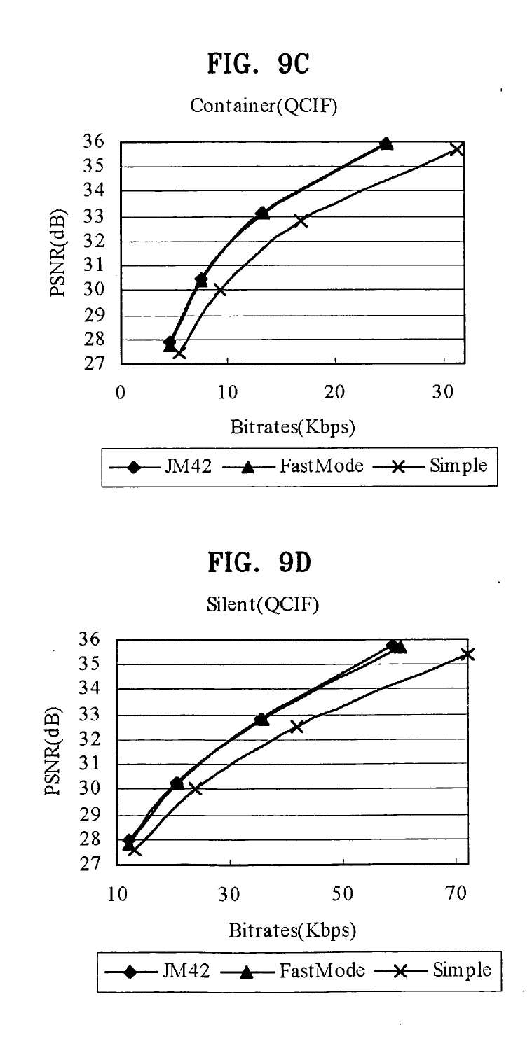

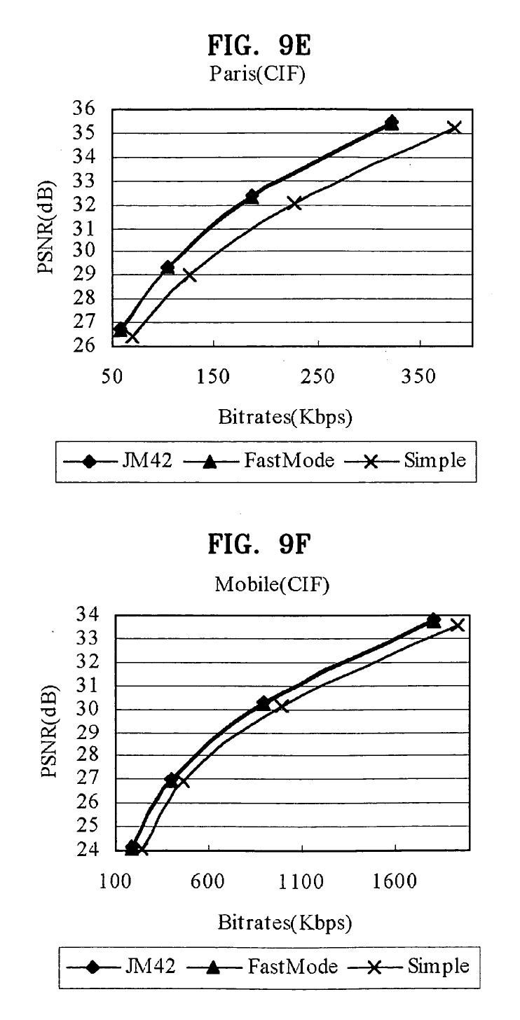

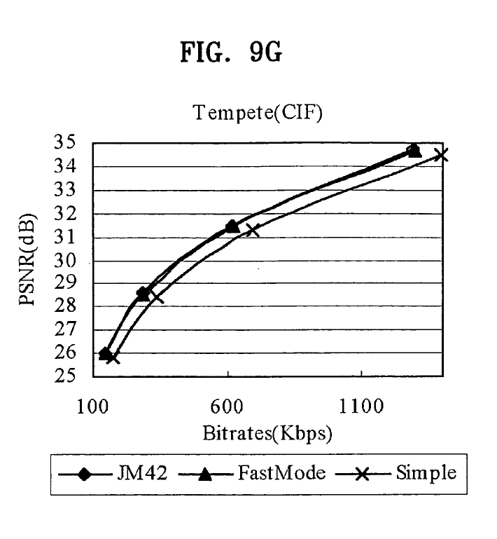

FIGS. 9A through 9G are graphs comparing PSNRs when a method of encoding mode determination of the present invention, H.264 method, and Simple H.264 are used, respectively.

The graphs of FIGS. 9A through 9G show the results of comparing performances of bitrates to PSNRs of the three methods in each of the standard test pictures, where the method of mode determination of the present invention (identified as FastMode in FIGS. 9A through 9G), JM42, and Simple H.264 were applied to pictures for experiment having various QCIF, CIF resolutions given in Table 2. In FIGS. 9A through 9G, data corresponding to the JM42 are identified with a diamond; data corresponding to the Fastmode are identified with a triangle; and data corresponding to the Simple H.264 are identified with a letter X. Referring to FIGS. 9A through 9G, the data shows that the PSNR of the method of mode determination of the present invention almost achieves the same result as H.264. That is, where the method of mode determination of the present invention is used for encoding, the encoding efficiency is almost the same as the encoding efficiency of H.264. Referring to FIGS. 9A through 9G and Tables 3a and 3b, where encoding is performed by using the method of mode determination of the present invention, the same encoding efficiency as H.264 is maintained while the amount of computation is reduced greatly.

The method of mode determination according to the present invention may be implemented as a computer program. Codes and code segments forming the program may be implemented based on the description provided herein. and stored in a computer readable media. When read and executed by a computer a method of reference frame determination and motion compensation according to the present invention may be performed. The computer readable media may include a magnetic storage media, an optical storage media and a carrier wave media.

According to the present invention as described above, by omitting variable block motion estimation and spatial prediction encoding that are the most complicated operations in an H.264 encoder, determining an encoding mode is fast performed through rate-distortion optimization such that encoding speed increases.

Where the method of encoding mode determination of the present invention is used, and rate-distortion is optimized, the frequency of RDcost calculations may be reduced by at least 75% in average, while the losses of bitrate and PSNR, which are two criteria indicating encoding efficiency, are very low. Accordingly, the method of the present invention may be used usefully to implement a high speed encoder.

Although a few embodiments of the present invention have been shown and described, it would be appreciated by those skilled in the art that changes may be made in this embodiment without departing from the principles and spirit of the invention, the scope of which is defined in the claims and their equivalents.

1. A method of determining an encoding mode, comprising:
performing motion estimation of a macro block in an inter16×16 mode, an inter16×8 mode, and an inter8×16 mode;
determining whether to further perform motion estimation in a P8×8 mode;
according to the determination result, omitting or performing motion estimation in the P8×8 mode and then selecting one mode from among the modes for which motion estimation has been performed; and
omitting or further performing spatial prediction encoding according to a rate-distortion cost of the selected mode and determining a final encoding mode.

2. The method of claim 1, wherein the determining of whether to further perform motion estimation in P8×8 mode comprises:
for each of the Inter16×16 mode, the Inter16×8 mode, and the Inter8×16 mode,
calculating a sum of absolute difference (SAD) value, which is a difference of a pixel value of a current picture and a pixel value of a previous picture, and
calculating MVcost, which is a difference value of a motion vector of the current picture and a motion vector of the previous picture; and
comparing a sum of the SAD and MVcost values (SAD+MVcost) of the respective modes and determining whether to further perform motion estimation in the P8×8 mode based on the comparison.

3. The method of claim 2, wherein in the determining of whether to further perform motion estimation in the P8×8 mode, if the (SAD+MVcost) value in the Inter16×16 mode is smaller than the (SAD+MVcost) values in other modes, motion estimation in the P8×8 mode is omitted.

4. The method of claim 2, wherein the omitting or performing motion estimation in the P8×8 mode and then determining the one mode comprises:
if the (SAD+MVcost) value in the Inter16×16 mode is smaller than the (SAD+MVcost) values in the other modes, calculating rate-distortion costs in the Inter16×16 mode, the Inter16×8 mode, the Inter8×16 mode, and a SKIP mode; and
selecting one mode which has a smallest rate-distortion cost among the modes.

5. The method of claim 2, wherein the omitting or performing motion estimation in the P8×8 mode and then determining the one mode comprises:
if the (SAD+MVcost) value in the Inter16×16 mode is not smaller than the (SAD+MVcost) values in the other modes,
calculating rate-distortion costs in an Inter8×8 mode, an Inter8×4 mode, an Inter4×8 mode and an Inter4×4 mode,
selecting one mode which has a smallest rate-distortion cost from among the Inter8×8 mode, the Inter8×4 mode, the Inter4×8 mode and the Inter4×4 mode,
determining whether calculation of a rate-distortion cost in an IBLOCK mode is needed, and
calculating a rate-distortion cost in IBLOCK mode and selecting one mode from among the Inter8×8 mode, the Inter 8×4 mode, the Inter4×8 mode, the inter 4×4 mode, and the IBLOCK mode, if the calculation in the IBLOCK mode is needed.

6. The method of claim 5, wherein in the determining of whether calculation of the rate-distortion cost in the IBLOCK mode is needed,
if the rate-distortion cost in the selected mode is not less than one-fourth of the average value of the rate-distortion costs of all macro blocks previously encoded in spatial prediction mode, motion estimation is further performed in IBLOCK mode and the rate-distortion cost in the IBLOCK mode is calculated.

7. The method of claim 2, wherein the omitting or further performing spatial prediction encoding according to the rate-distortion cost value in the selected mode, and the determining of the final encoding mode comprises:
if the rate-distortion cost value in the selected mode is less than an average value of rate-distortion costs of all macro blocks previously encoded in the spatial prediction mode, motion estimation in Intra mode is not performed and the selected mode is determined as a final encoding mode; and
if the rate-distortion cost value in the determined mode is not less than the average value of rate-distortion costs of all macro blocks previously encoded in spatial prediction mode, motion estimation in Intra mode is further performed and the rate-distortion cost in the Intra mode is calculated, and by comparing the rate-distortion cost in the intra mode with the rate-distortion cost in the selected mode, a mode having a smaller value is determined as the final encoding mode.

8. The method of claim 7, wherein in the determining of a final encoding mode after performing motion estimation in the Intra mode is further performed, if the Intra mode is determined as the final encoding mode, the average value of rate-distortion costs of all macro blocks previously encoded in spatial prediction mode is updated based on the calculated rate-distortion cost in the intra mode.

9. The method of claim 8, wherein the updating of the average value is performed by multiplying the average value by the number of Intra macro blocks previously occurring, adding the multiplication result to the calculated rate-distortion cost in the Intra mode, and dividing the addition result by the number of Intra macro blocks previously occurring plus one.

10. A method of motion estimation of a macro block comprising:
performing motion estimation by using an entire macro block;
dividing the macro block into two in the horizontal direction or the vertical direction and then performing motion estimation by using each divided block;
dividing the macro block into 4 blocks of an identical size and performing motion estimation by using each divided block;
dividing each of the four divided blocks into two in the horizontal direction or the vertical direction and performing motion estimation by using each further divided block; and
dividing each of the four divided blocks into four and performing motion estimation by using each further divided block.

11. The method of claim 10, wherein in the performing of motion estimation by using the entire macro block, motion estimation is performed by using the entire macro block of a 16×16 size.

12. The method of claim 10, wherein in the dividing of the macro block into two in the horizontal direction or the vertical direction and then performing motion estimation by using each divided macro block, motion estimation for the macro block is performed by using two 16×8 blocks and then by using two 8×16 blocks.

13. The method of claim 10, wherein in the dividing of the macro block into 4 blocks of an identical size and performing motion estimation by using each divided block, motion estimation for the macro block is performed by using two 16×8 blocks and then by using two 8×16 blocks.

14. An encoding apparatus comprising:
a DCT+Q performing unit which receives picture data and performs discrete cosine transform (DCT) and quantization;
a rate-distortion optimization unit which calculates a rate-distortion cost of the picture data and determines an encoding block mode to be used in encoding the picture, and transfers the determined block mode to the DCT+Q performing unit; and
a motion estimator and a motion compensator which by using a reference frame and the input picture, performs motion estimation and compensation and transfers the result to the DCT+Q performing unit.

15. The encoding apparatus of claim 14, wherein the rate-distortion optimization unit calculates a sum of absolute difference (SAD) value that is a difference of a pixel value of a current picture and a pixel value of a previous picture, in the input picture data, and MVcost that is a difference value of a motion vector of the current picture and a motion vector of the previous picture, and according to a value (SAD+MVcost), omits motion estimation in spatial prediction mode.

16. A method of determining an encoding mode, comprising:
performing motion estimation of a macro block in a plurality of modes including an inter16×16 mode, an inter16×8 mode, and an inter8×16 mode;
determining a SAD value, an MVcost value and a sum of the SAD value and the MVcost value (SAD+MVcost) for each of the plurality of modes, the SAD value being a difference of a pixel value of a current picture and a pixel value of a previous picture and the MVcost value being a difference value of a motion vector of the current picture and a motion vector of a previous picture;
calculating a rate distortion cost (RDcost) in each of the plurality of modes and in a skip mode, if the (SAD+MVcost) for the inter 16×16mode is smaller than the (SAD+MVcost) corresponding to the other ones of the plurality of modes;
selecting the mode having the smallest RDcost from among the plurality of modes and the skip mode; and
if the RDcost of the selected mode is less than M, determining the selected mode as the encoding mode, where M is a mean RDcost value of a plurality Intra macro blocks encoded in a spatial prediction mode and occurring in previous frames.

17. The method of claim 16, wherein, if the RDcost of the selected mode is not less than M:
calculating an RDcost in Intra mode; and
determining the one of the Intra mode and the selected mode having the smallest RDcost as the encoding mode.

18. A method of determining an encoding mode, comprising:
performing motion estimation of a macro block in a first plurality of modes comprising an inter16×16 mode, an inter16×8 mode, and an inter8×16 mode;
determining a SAD value, an MVcost value and a sum of the SAD value and the MVcost value (SAD+MVcost) for each of the first plurality of modes, the SAD value being a difference of a pixel value of a current picture and a pixel value of a previous picture and the MVcost value being a difference value of a motion vector of the current picture and a motion vector of a previous picture;
performing motion estimation in a each of a second plurality of modes, if the (SAD+MVcost) for the inter16×16 mode is not smaller than the (SAD+MVcost) corresponding to the other ones of the first plurality of modes, the second plurality of modes comprising an Inter8×8 mode, an Inter8×4mode, an Inter4×8mode and an inter 4×4mode;
calculating an RDcost value for each of the second plurality of modes;
selecting the mode from among the second plurality of modes having the smallest RDcost, if the RDcost of the mode having the smallest RDcost is less than M/4, where M is a mean RDcost value of a plurality of Intra macro blocks occurring in previous frames and encoded in a spatial prediction mode; and
if the RDcost of the selected mode is less than M, determining the selected mode as the encoding mode,

19. The method of claim 18, wherein, if the RDcost of the selected mode is not less than M:
calculating an RDcost in Intra mode; and
determining the one of the Intra mode and the selected mode having the smallest RDcost as the encoding mode.
